(19) United States
(12) Patent Application Publication
(10) Pub. No.: US 2006/0021764 A1
(43) Pub. Date: Feb. 2, 2006

(54) Piercing tool

(75) Inventors: David W. Archer, Hortonville, WI (US); Ryan F. Rowe, Oshkosh, WI (US); Gary Schmiedel, Oshkosh, WI (US); Terry G. Seaborn, Oshkosh, WI (US)

Correspondence Address: FOLEY & LARDNER LLP, 777 EAST WISCONSIN AVENUE, SUITE 3800, MILWAUKEE, WI, 53202-5308, US

(73) Assignee: Oshkosh Truck Corporation

(21) Appl. No.: 10/901,903

(22) Filed: Jul. 29, 2004

(51) Int. Cl. A62C 27/00

(52) U.S. Cl. 169/24; 169/70; 239/271

(57) ABSTRACT

A piercing tool for use with a piercing nozzle assembly is disclosed. The piercing tool comprises a member having first and second ends. The first end comprises a cutting edge formed by the intersection of a first surface and a second surface. The first surface is a tapered outer surface of the member and the second surface defines a cavity within the member. The second end is configured to facilitate coupling the piercing tool to the piercing nozzle assembly.

### FIELD

The present invention relates generally to piercing tools and particularly to a piercing tool for use with a fire-fighting vehicle having a piercing nozzle assembly.

### BACKGROUND

Fire-fighting type vehicles and particularly airport rescue fire-fighting vehicles have a variety of equipment and apparatuses utilized during fire-fighting and rescue operations. For example, the fire-fighting vehicle may have a fluid dispensing arrangement such as an aerial boom with a piercing nozzle assembly on the outer end of the boom mechanism. Typically, the aerial boom is mounted on the top side of the vehicle at about its midsection. The aerial boom then articulates or telescopes to various positions which can include in front of the vehicle.

The fluid dispensing arrangement may be provided with a piercing tool coupled to a piercing nozzle of a piercing nozzle assembly such that the piercing nozzle can penetrate the wall of a structure containing a fire, such as an airplane fuselage or a building. In order to facilitate penetration of the structure, the piercing tool typically includes a point configured to pierce the structure. A force is applied to the piercing tool by, for example, advancing the vehicle or the aerial boom such that the piercing tool and the piercing nozzle penetrate the structure. Once the piercing nozzle has penetrated the structure, a flame-retardant fluid or material may be dispensed within the structure.

A piercing tool with a point may have difficulty in penetrating the structure at certain angles. Specifically, if the piercing tool is not perpendicularly aligned with the structure to a significant degree before piercing, it may slip and glance off the surface instead of piercing it. Several attempts at perpendicularly aligning the piercing tool may be required before the structure is penetrated, which in turn prolongs the time before the fire may be extinguished.

Thus, there is need for an improved piercing tool for use with a fire-fighting vehicle which is capable of penetrating a structure such as an airplane fuselage or building from a number of different angles without a significantly high degree of perpendicular alignment with the surface of the structure.

### SUMMARY

According to an exemplary embodiment, a piercing tool for use with a piercing nozzle assembly comprises a member having first and second ends. The first end comprises a cutting edge formed by the intersection of a first surface and a second surface. The first surface is a tapered outer surface of the member and the second surface defines a cavity within the member. The second end is configured to facilitate coupling the piercing tool to the piercing nozzle assembly.

According to another exemplary embodiment, a vehicle comprises a support structure, at least one driven axle and wheel assembly coupled to the support structure, a power source coupled to the axle and wheel assembly for driving the axle and wheel assembly, an aerial boom coupled to the support structure, and a piercing nozzle assembly coupled to the aerial boom and including a piercing tool. The piercing tool includes a cutting edge formed by the intersection of a first outer surface of a tapered member and a second surface defining a cavity within the member.

According to another exemplary embodiment, a method of producing a piercing tool for use with a vehicle having a piercing nozzle assembly comprises providing a member having a first end and a second end, and configuring the first end such that a cutting edge is formed by the intersection of a first surface and a second surface. The first surface is a tapered outer surface of the member and the second surface defines a cavity within the member. The method also includes configuring the second end to facilitate coupling the piercing tool to the piercing nozzle assembly.

Other features and advantages of the present invention will become apparent from the following detailed description and accompanying drawings. It should be understood, however, that the detailed description and specific examples are given by way of illustration and not limitation. Many modifications and changes within the scope of the present invention may be made without departing from the spirit thereof, and the invention includes all such modifications.

### BRIEF DESCRIPTION OF THE DRAWINGS

The exemplary embodiments will hereafter be described with reference to the accompanying drawings, wherein like numerals depict like elements, and:

FIG. 1A is a perspective view of a vehicle according to an exemplary embodiment;

FIG. 1B is a side view of the vehicle shown in FIG. 1A according to an exemplary embodiment;

FIG. 2A is a perspective view of a piercing tool according to an exemplary embodiment;

FIG. 2B is a side view of the piercing tool shown in FIG. 2A according to an exemplary embodiment;

FIG. 3A is a diagram illustrating an exemplary application of the piercing tool shown in FIG. 2A and FIG. 2B wherein the piercing tool is employed to penetrate a structure; and

FIG. 3B is a diagram illustrating another exemplary application of the piercing tool shown in FIG. 2A and FIG. 2B wherein the piercing tool is employed to penetrate a structure.

### DETAILED DESCRIPTION

Before turning to the FIGURES which illustrate the exemplary embodiments in detail, it should be understood that the invention is not limited to the details or methodology set forth in the following description or illustrated in the FIGURES. The invention is capable of other embodiments or being practiced or carried out in various ways. It should also be understood that the phraseology and terminology employed herein is for the purpose of description only and should not be regarded as limiting.

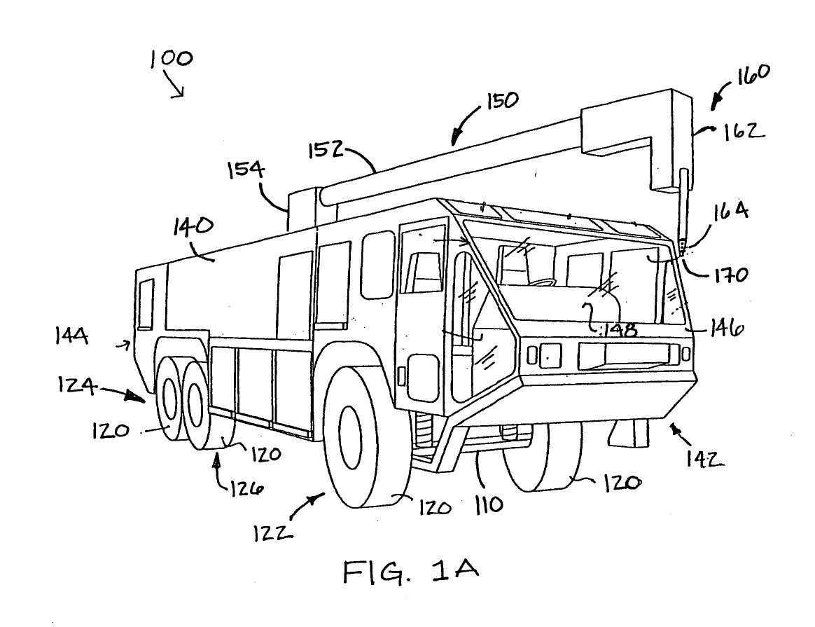

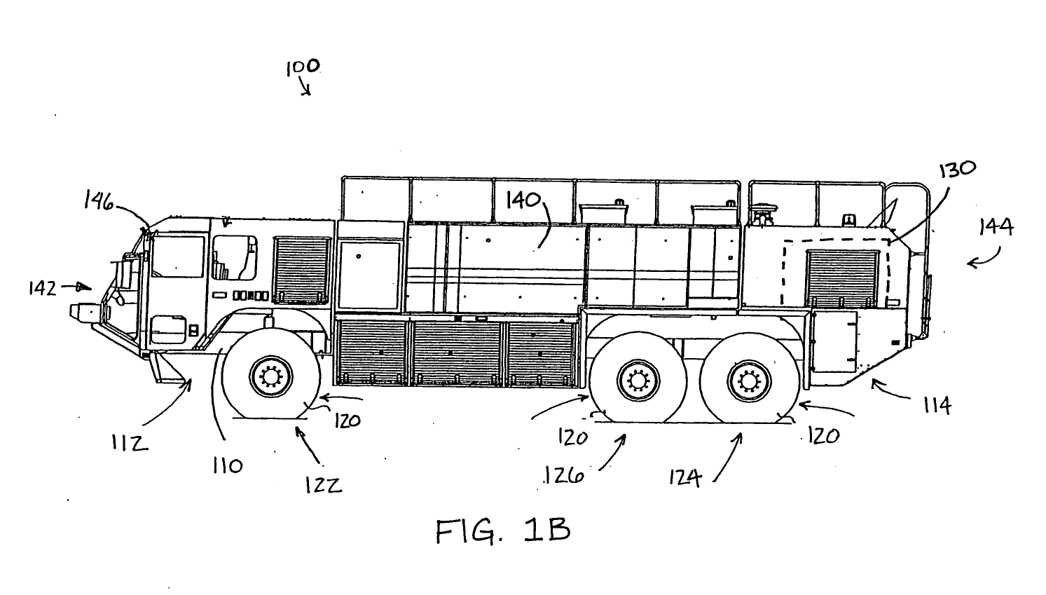

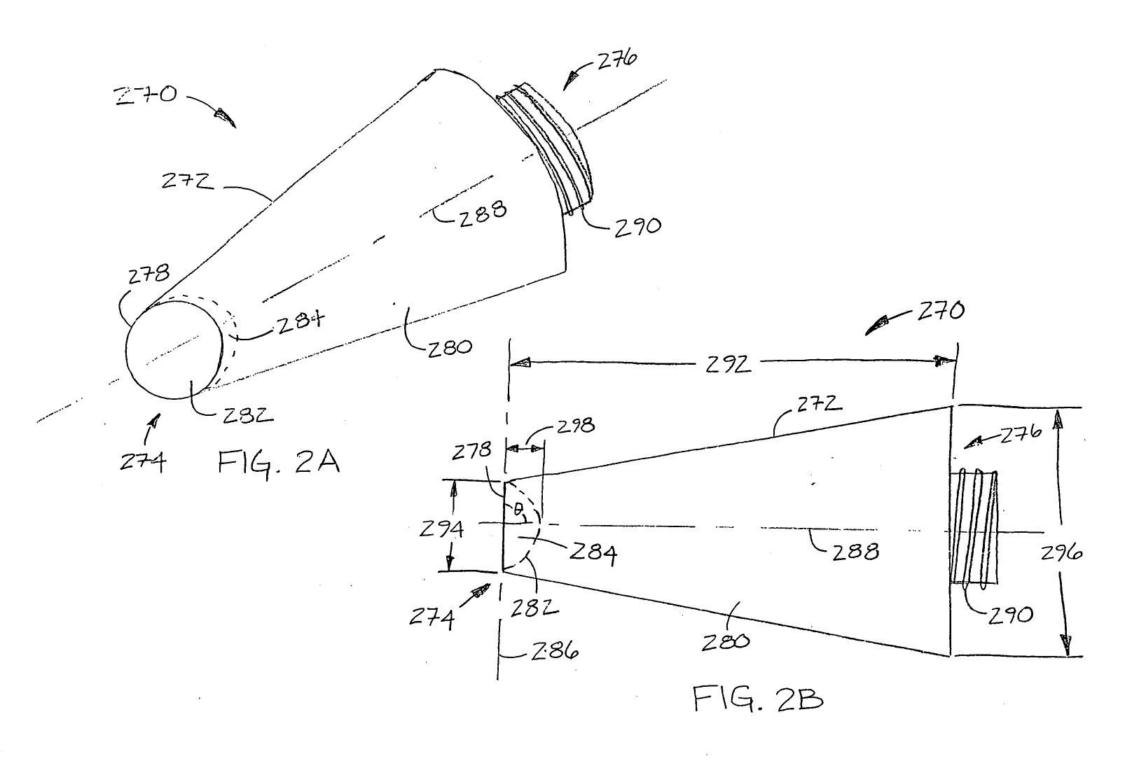

In general, the piercing tool disclosed herein may be used in conjunction with a vehicle having a piercing nozzle assembly in order to penetrate a structure in a fire-fighting or rescue operation. FIGS. 1 and 2 illustrate a vehicle 100 according to an exemplary embodiment. Vehicle 100 may be of several different types and configured for several different uses. For example, vehicle 100 may be a fire-fighting vehicle or rescue vehicle configured to fight structural building fires and the like. Vehicle 100 may also be an airport rescue and fire-fighting vehicle (ARFF) or crash truck configured to fight aircraft fires, fuel fires, and the like. An exemplary application of an ARFF or crash truck is for it to be called upon in the event of an aircraft fire or crash at or near an airport.

Vehicle 100 includes a support structure 110, a plurality of ground engaging motive members 120, a power source 130, a vehicle body 140, an aerial boom 150, and a piercing nozzle assembly 160 having a piercing tool 170. Support structure 110 has a front end 112 and a rear end 114. Support structure 110 is generally configured to provide a structural support base for the various components of vehicle 100.

Ground-engaging motive members 120 are coupled to support structure 110. For purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. By way of example, ground-engaging motive members 120 may be coupled to support structure 110 by a suspension system such that support structure 100 is supported relative to each ground engaging motive member. According to an exemplary embodiment, the suspension system is a modular independent suspension system including a coil spring suspension for steerable and non-steerable wheel assemblies and drive and non-drive axles.

Ground engaging motive members 120 include, for example, wheels (e.g., cast or machined and including rubber or composite tires, etc.), axle and wheel assemblies, or assemblies including articulated tracks (e.g., metal, rubber, composite, etc.), and the like which may be used to maintain support structure 110 above a surface and to allow vehicle 100 to move across the surface. Several configurations of ground engaging motive members 120 are possible (e.g., four, six and eight wheel arrangements, etc.), as commensurate with the type duty that will be experienced by vehicle 100. For example, in the illustrated embodiment, ground engaging motive members 120 include at least two axle and wheel assemblies coupled to support structure 110. A front axle and wheel assembly 122 is coupled to front end 112 of support structure 110, and a rear axle and wheel assembly 124 is coupled to rear end 114 of support structure 110. An optional intermediate axle and wheel assembly 126 is shown coupled to rear end 114 of support structure 110, such that vehicle 100 has a six wheel configuration.

Power source 130 is mounted to support structure 110 and is coupled to at least one of ground-engaging motive members 120 such that it may be driven by power source 130. In other embodiments, power source 130 is coupled to multiple ground engaging members, such as in an all-wheel drive system. According to an exemplary embodiment, power source 130 is an internal combustion engine, such as a gasoline or diesel engine. According to other exemplary embodiments, power source 130 may include a turbine engine, an electric motor, a hybrid-electric system, or the like.

Vehicle body 140 is coupled to support structure 110 and includes a front end 142, and a rear end 144. A vehicle cab 146, including an operator station 148, is typically disposed at front end 142 of vehicle body 140. Any convenient and conventional materials may be utilized to form vehicle body 140, such as steel, aluminum, or a composite material. Vehicle body 140 is configured to at least partially enclose power source 130. Vehicle body 140 is also configured to at least partially house one or more fluid or chemical tanks mounted to support structure 110. Exemplary fluid tanks may include a water tank, a chemical flame-retardant tank, and the like.

Aerial boom 150 comprises a member 152 pivotally coupled to vehicle 100 by way of mounting assembly 154. Member 152 is coupled to piercing nozzle assembly 160 which is configured to couple to piercing tool 170. According to various exemplary embodiments, member 152 may be fixed in length or alternatively may be adjustable in length. Further, member 152 may comprise a telescopic configuration for extending and retracting in length. Furthermore, member 152 may comprise one or more joints for pivotal movement. According to an exemplary embodiment, aerial boom 150 may comprise any number of members coupled together and/or to other objects according to any suitable arrangement.

Piercing nozzle assembly 160 is coupled to the end of aerial boom 150 and typically includes a motion assembly 162, a piercing nozzle 164 coupled to motion assembly 162, and a piercing tool 170 coupled to piercing nozzle 164. Motion assembly 162 is configured to control the motion of piercing nozzle assembly 162 in both the horizontal and vertical directions. Motion assembly 162 can be controlled either manually or remotely from vehicle 100 (e.g., using operator station 148) depending on the particular circumstances in which vehicle 100 is being utilized. Motion assembly 162 will typically include a motor, gears, and levers that will impart controlled motion to piercing nozzle assembly 162. Piercing nozzle 164 is typically coupled to a fluid source and is shaped as a frustum with a hollow passage therein and includes a plurality of openings configured to dispense a pressurized fluid or other material from the fluid source. Piercing tool 170 is generally configured to penetrate a structure so that piercing nozzle assembly 160 may dispense the pressurized fluid or other material inside the structure.

The fluid source can be mounted directly on vehicle 100, such as a fluid tank or chemical tank. The fluid source may also be an independent fluid source, such as a separate trailer structure, a separate tank vehicle, or a fixed fluid source, such as a lake, river, reservoir, tank, public or municipal utility source (e.g., a hydrant coupled to a pressurized fluid source), etc. The independent fluid source may be coupled to vehicle 100 for pumping purposes.

FIGS. 2A and 2B illustrate a piercing tool 270 according to an exemplary embodiment. Piercing tool 270 includes a member 272 having an end 274 and an end 276. Piercing tool 270 is generally configured to penetrate a wall of a structure, such as a building or an airplane fuselage, so that a flame-retardant fluid or material may be dispensed within the structure by a piercing nozzle assembly during fire-fighting and rescue operations. More specifically, piercing tool 270 is configured to penetrate a structure such as a building or an airplane fuselage from a number of different angles without requiring a significantly high degree of perpendicular alignment with the surface of the structure.

End 274 includes a cutting edge 278 formed by the intersection of a surface 280 and a surface 282 and configured to facilitate the penetration of a structure from a number of different angles without requiring a significantly high degree of perpendicular alignment with the surface of the structure. Cutting edge 278 may have a variety of different configurations depending upon the shape of the intersection of surface 280 and surface 282. For example, in the illustrated embodiment, the intersection of surface 280 and surface 282 is circular in shape, which provides an annular cutting edge 278. According to other embodiments, cutting edge 278 is configured as other shapes, such as other elliptical shapes, ovular shapes, many-sided shapes, etc. Cutting edge 278 may have also variety of different configurations depending upon the orientation of the intersection of surface 280 and surface 282. For example, in the illustrated embodiment, surface 280 and surface 282 intersect in a plane 286 according to an angle θ such that plane 286 is substantially perpendicular to a longitudinal axis 288 of member 272. According to other exemplary embodiments, different angles and planes of intersection are used to define cutting edge 278.

Surface 280 is a tapered outer surface of member 272, with the surface tapering toward end 274 such that end 274 is narrower in width or diameter than end 276. Surface 280 may be a number of different shapes. For example, in the illustrated embodiment, Surface 280 has the shape of an elliptical frustum having a circular cross section. Other exemplary shapes of surface 280 include frustums or other tapered extrusions having ovular, egg-shaped, or many-sided cross sections, etc.

Surface 282 defines a cavity 284 within member 272. Surface 282 and cavity 284 may be a number of different shapes. For example, in the illustrated embodiment, surface 282 is a concave surface such that cavity 284 is shaped as a section of a sphere. Other exemplary configurations of surface 282 and cavity 284 include frustums, conics, cylinders, etc.

End 276 is configured to facilitate the coupling of piercing tool 270 to piercing nozzle assembly 160 shown in FIG. 1. Any common means of attachment, such as welding, brazing, interlocking configurations, etc., may by used to couple piercing tool 270 to piercing nozzle assembly 160. For example, in the illustrated embodiment, End 276 includes screw-type mating threads 290 for removably coupling piercing tool 270 to piercing nozzle assembly 160 so that piercing tool 270 may be replaced if, for example, it breaks or becomes dull.

Piercing tool 270 may be formed from various different materials. According to an exemplary embodiment, piercing tool 270 is formed from a durable rigid material. For example, piercing tool 270 may be made from metal, alloys, steel, composites, etc. In addition, according to various other embodiments, piercing tool 270 is optionally coated or plated with a material such as chrome, or heat treated or plated with a hardened coating such as tungsten carbide.

Piercing tool 270 may have varying overall size and dimensions based on, for example, the particular piercing application, the thickness and material of the structure to be pierced, the strength of the components to which piercing tool 270 is attached, etc. For example, according to an exemplary embodiment, piercing device 270 is configured to penetrate an aluminum aircraft fuselage and has a length 292 of approximately four inches, a width or diameter 294 of end 274 of approximately three quarters of an inch, a width or diameter 296 of end 276 of approximately one quarter of an inch, and a depth 298 of cavity 284 of approximately one eighth of an inch. According to other exemplary embodiments, these dimensions are varied as applicable.

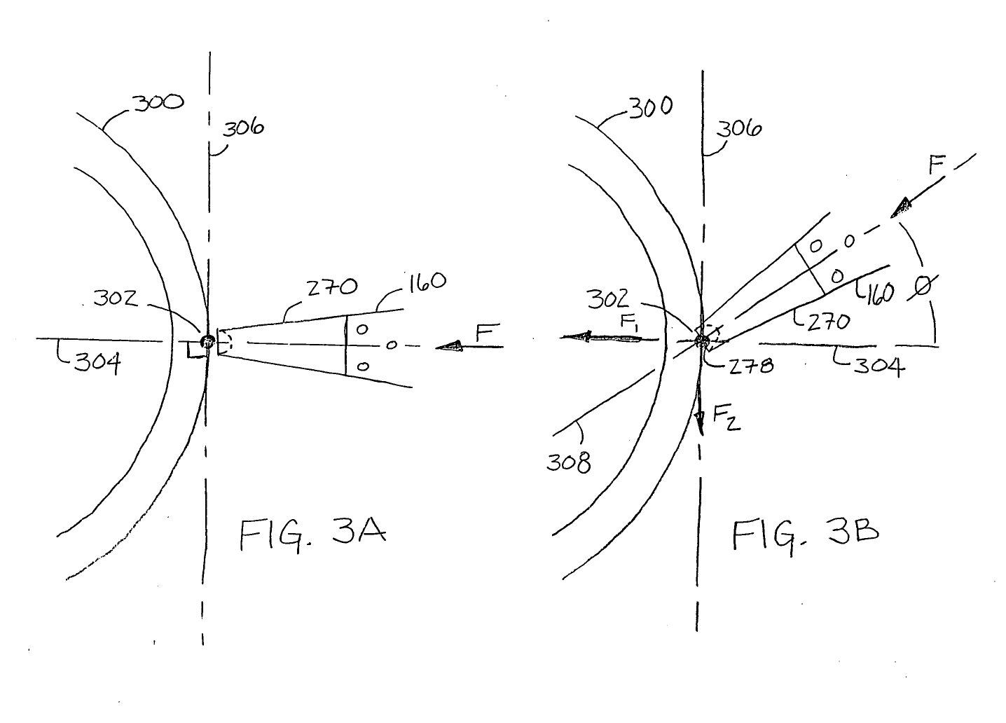

FIGS. 3A and 3B illustrate exemplary applications of piercing tool 270, wherein piercing tool 270 is employed to penetrate a structure 300. Referring to FIG. 4A, piercing tool 270 is shown coupled to piercing nozzle assembly 160 and aligned with a point of impact 302 on structure 300. Specifically, piercing tool 270 is shown as being longitudinally aligned with point of impact 302 along an axis 304 passing through point of impact 302. Axis 304 is perpendicularly aligned with an axis 306 that is tangent to point of impact 302. Piercing tool 270 may be advanced through point of impact 302 to penetrate structure 300 by applying a force F to piercing tool 270 along axis 304. Force F is applied to piercing tool 270 by, for example, advancing the vehicle or the aerial boom such that piercing tool 270 and the nozzle portion of piercing nozzle assembly 270 penetrate the structure. Because the orientation of piercing device 270 along axis 304 allows force F to be applied perpendicular to axis 306 and structure 300 at point of impact 302, the entire force F is able to advance piercing tool 270 through structure 300 along axis 304 without slippage along axis 306.

Referring to FIG. 4B, piercing tool is shown coupled to piercing nozzle assembly 160 and aligned with point of impact 302 on structure 300. Specifically, piercing tool 270 is shown as being longitudinally aligned with point of impact 302 along an axis 308 passing through point of impact 302. Axis 308 is not perpendicularly aligned with axis 304, but rather is offset from axis 304 according to an angle φ. With this alignment, when a force F is applied to piercing tool 270 along axis 308, force F will have a component F₁ aligned with axis 304 and given by (F)cos(φ) and a component F₂ aligned with axis 306 and given by (F)sin(φ). Depending upon factors such as the material of structure 300 and the magnitude of force F, the portion of cutting edge 278 in contact with structure 300 prevents component F₂ from causing piercing tool to slip off point of impact 302 for a given range of angle φ about axis 304. Within this range, cutting edge 278 will cut into the surface of structure 300 (e.g., by forming a burr or notch on the surface) such that component F₂ is sufficiently offset and piercing tool 270 may be advanced through structure 300 along axis 308 without slippage. According to an exemplary embodiment, piercing tool 270 is configured to penetrate an aluminum aircraft fuselage over a range of angle φ of approximately ±20 degrees of axis 304.

The foregoing description of embodiments has been presented for purposes of illustration and description. It is not intended to be exhaustive or to be limited to the precise forms disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. It is intended that the scope of the invention be defined by the claims appended hereto and their equivalents.

What is claimed is:

1. A piercing tool for use with a piercing nozzle assembly, the piercing tool comprising:
a member having first and second ends;
wherein the first end comprises a cutting edge formed by the intersection of a first surface and a second surface;
wherein the first surface is a tapered outer surface of the member and the second surface defines a cavity within the member; and
wherein the second end is configured to facilitate coupling the piercing tool to the piercing nozzle assembly.

2. The piercing tool of claim 1, wherein first surface of the member is substantially shaped as an elliptical frustum.

3. The piercing tool of claim 1, wherein the first end comprises an annular cutting edge.

4. The piercing tool of claim 1, wherein the second surface is a concave surface.

5. The piercing tool of claim 1, wherein the first and second surfaces intersect at a plane substantially perpendicular to a longitudinal axis of the member.

6. The piercing tool of claim 1, wherein the second end comprises threaded means for coupling the piercing tool to the piercing nozzle assembly.

7. The piercing tool of claim 1, wherein the piercing nozzle assembly is configured to be used with a fire-fighting vehicle.

8. The piercing tool of claim 1, wherein the piercing nozzle assembly is configured to be used with an airport rescue and fire-fighting vehicle.

9. A vehicle comprising:
a support structure;
at least one driven axle and wheel assembly coupled to the support structure;
a power source coupled to the axle and wheel assembly for driving the axle and wheel assembly;
an aerial boom coupled to the support structure; and
a piercing nozzle assembly coupled to the aerial boom and including a piercing tool, wherein the piercing tool includes a cutting edge formed by the intersection of a first outer surface of a tapered member and a second surface defining a cavity within the member.

10. The vehicle of claim 9, wherein the first surface is substantially shaped as an elliptical frustum.

11. The vehicle of claim 9, wherein the cutting edge is annular in shape.

12. The vehicle of claim 9, wherein the second surface is a concave surface.

13. The vehicle of claim 9, wherein the first and second surfaces intersect at a plane substantially perpendicular to a longitudinal axis of the piercing tool.

14. The vehicle of claim 9, wherein the piercing tool further includes threaded means for coupling the piercing tool to the piercing nozzle assembly.

15. The vehicle of claim 9, wherein the vehicle is configured as a fire-fighting vehicle.

16. The vehicle of claim 9, wherein the vehicle is configured as an airport rescue and fire-fighting vehicle.

17. The vehicle of claim 9, wherein the power source is an internal combustion engine.

18. The vehicle of claim 9, wherein the power source is an electric motor.

19. The vehicle of claim 9, further comprising a fluid source coupled to the piercing nozzle assembly.

20. A method of producing a piercing tool for use with a vehicle having a piercing nozzle assembly, the method comprising:
providing a member having a first end and a second end;
configuring the first end such that a cutting edge is formed by the intersection of a first surface and a second surface, wherein the first surface is a tapered outer surface of the member and the second surface defines a cavity within the member; and
configuring the second end to facilitate coupling the piercing tool to the piercing nozzle assembly.

21. The method of claim 20, further comprising configuring the first surface to be substantially shaped as an elliptical frustum.

22. The method of claim 20, further comprising configuring the first end as an annular cutting edge.

23. The method of claim 20, further comprising configuring the second surface as a concave surface.

24. The method of claim 20, further comprising configuring the first and second surfaces to intersect at a plane substantially perpendicular to a longitudinal axis of the member.

25. The method of claim 20, further comprising configuring the second end with threaded means for coupling the piercing tool to the piercing nozzle assembly.

26. The method of claim 20, further comprising providing a vehicle configured as a fire-fighting vehicle.

27. The method of claim 20, further comprising providing a vehicle configured as an airport rescue and fire-fighting vehicle.
